(19) United States
(12) Patent Application Publication
(10) Pub. No.: US 2026/0195665 A1
(43) Pub. Date: Jul. 9, 2026

(54) USER INTERFACE FOR EFFICIENT AND INTUITIVE TRAVEL ITINERARY SELECTION

(71) Applicant: Peter G. Khoury, San Francisco, CA (US)

(72) Inventor: Peter G. Khoury, San Francisco, CA (US)

(21) Appl. No.: 19/442,385

(22) Filed: Jan. 7, 2026

Related U.S. Application Data
(60) Provisional application No. 63/742,803, filed on Jan. 7, 2025.

(51) Int. Cl. G06Q 10/02

(52) U.S. Cl. CPC G06Q 10/025

(57) ABSTRACT

An electronic device may obtain itinerary information associated with an individual. Then, the electronic device may access or receive travel alternatives based at least in part on the itinerary information. Moreover, the electronic device may select a subset of the travel alternatives based at least in part on one or more travel constraints. Next, the electronic device may compute, using a clustering technique, groups of the subset of travel alternatives, where a given group in the subset of travel alternatives includes a set of one or more travel alternatives having at least one common characteristic, and the travel alternatives in different clusters are different from each other in at least one travel constraint. Furthermore, the electronic device may provide the groups of the subset of the travel alternatives, where the providing includes providing instructions for a user interface that presents the groups of the subset of the travel alternatives.

### CROSS REFERENCE TO RELATED APPLICATIONS

This application claims priority under 35 U.S.C. 119(e) to: U.S. Provisional Application Ser. No. 63/742,803, “User Interface for Efficient and Intuitive Travel Itinerary Selection,” filed on Jan. 7, 2025, by Peter G. Khoury, et al., the contents of which are herein incorporated by reference.

### FIELD

The described embodiments relate to techniques for selecting a travel itinerary based at least in part on one or more constraints.

### BACKGROUND

Itinerary choices when traveling can be complicated decisions for individuals to make. Individuals and companies making travel and itinerary decisions usually weigh many different factors and considerations before arriving at what they consider to be the best choice. Some of the factors individuals may consider are expense, time of travel, duration of travel, mode of travel, and/or the provider.

Recently, more and more individuals have become aware of the environmental impacts of their actions and have been taking steps to lower those impacts. Notably, emissions from travel can be highly impactful on the environment, adding significant amounts of CO₂ and other greenhouse gases to the atmosphere. For example, an individual who wants to reduce the impact of their travel on the environment may want to understand for the consequences of various itineraries under consideration. Therefore, as climate change becomes more and more of a concern, some travelers may want to balance and consider the environmental impact of their itinerary along with all of the other factors listed above. However, an itinerary or travel decision that was already complicated prior to the consideration of the environment gets more complicated.

Additionally, an individual's intuition about the environmental impacts may not be accurate. Making the right choice for the environment usually cannot be reduced to a simple rules of thumb that would make itinerary and travel decisions easier. Thus, the environmental analysis is often more complicated than a simple slogan like ‘always fly direct,’ or ‘always drive and do not fly.’ There are a number of scenarios where simple rules fail, and an individual's intuition may lead them to reach the wrong conclusions about the environmental impact of itineraries.

Furthermore, many of the inputs or factors that affect the environmental impact may not be known or available to the individual, especially given the time-sensitive nature of travel decisions. Consequently, it can be difficult for eco-conscious travelers to make informed and responsible travel decisions.

### SUMMARY

In a first group of embodiments, an electronic device that provides recommendation information is described. This electronic device includes: an interface circuit, a processor, and memory storing program instructions. During operation, the electronic device obtains itinerary information associated with an individual. Then, the electronic device accesses or receives travel alternatives based at least in part on the itinerary information. Moreover, the electronic device selects a subset of the travel alternatives based at least in part on one or more travel constraints. Next, the electronic device computes, using a clustering technique, groups of the subset of travel alternatives, where a given group in the subset of travel alternatives includes a set of one or more travel alternatives having at least one common characteristic, and the travel alternatives in different clusters are different from each other in at least one travel constraint. Furthermore, the electronic device provides the groups of the subset of the travel alternatives, where the providing includes providing instructions for a user interface that presents the groups of the subset of the of travel alternatives.

Note that the travel alternatives may include different itineraries.

Moreover, the travel constraints may include a constraint on emissions (such as CO₂).

Furthermore, the electronic device may include a second group of travel alternatives in the instructions for the user interface, where the second group of travel alternatives includes one or more travel alternatives that were excluded based at least in part on the one or more travel constraints. Note that the second group of travel alternatives may have a different color from the groups of the subset of the travel alternatives in the instructions for the user interface.

Additionally, the one or more travel constraints may be user-defined.

In some embodiments, the electronic device may dynamically revise the groups of the subset of travel alternatives and/or may provide the revised groups of the subset of the travel alternatives based at least in part on one or more user selections associated with the user interface.

Note that the instructions for the user interface may include labels with values or summaries of the one or more travel constraints for the groups of the subset of the travel alternatives.

Another embodiment provides a computer-readable storage medium for use with the electronic device. When executed by the electronic device, this computer-readable storage medium causes the electronic device to perform at least some of the aforementioned operations or counterparts to at least some of the aforementioned operations.

Another embodiment provides a method, which may be performed by the electronic device. This method includes at least some of the aforementioned operations or counterparts to at least some of the aforementioned operations.

In a second group of embodiments, an electronic device that provides recommendation information using a user interface with a slider is described.

Another embodiment provides a computer-readable storage medium for use with the electronic device. When executed by the electronic device, this computer-readable storage medium causes the electronic device to perform at least some of the aforementioned operations or counterparts to at least some of the aforementioned operations.

Another embodiment provides a method, which may be performed by the electronic device. This method includes at least some of the aforementioned operations or counterparts to at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a drawing illustrating an example of a user interface in accordance with an embodiment of the present disclosure.

FIG. 3 is a drawing illustrating an example of a user interface in accordance with an embodiment of the present disclosure.

FIG. 4 is a drawing illustrating an example of a user interface in accordance with an embodiment of the present disclosure.

FIG. 5 is a drawing illustrating an example of a user interface in accordance with an embodiment of the present disclosure.

FIG. 6 is a drawing illustrating an example of a user interface in accordance with an embodiment of the present disclosure.

FIG. 7 is a drawing illustrating an example of a user interface in accordance with an embodiment of the present disclosure.

FIG. 8 is a drawing illustrating an example of a user interface in accordance with an embodiment of the present disclosure.

FIG. 9 is a flow diagram illustrating an example of a method for providing recommendation information using an electronic device in FIG. 1 in accordance with an embodiment of the present disclosure.

FIG. 10 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device that provides recommendation information is described. During operation, the electronic device may obtain itinerary information associated with an individual. Then, the electronic device may determine environmental factors associated with the itinerary information. Moreover, the electronic device may dynamically compute carbon footprints of multiple types of transportation based at least in part on the itinerary information and the environmental factors. For example, a given carbon footprint of a given type of transportation may include an incremental carbon footprint associated with the individual and a total carbon footprint of the given type of transportation. Next, the electronic device may provide recommendation information including the multiple types of transportation and the computed associated carbon footprints.

By providing the recommendation information, the recommendation techniques may provide transparency about the environmental costs associated with the types of transportation alternatives available to the individual. Moreover, because the environmental factors that impact the different types of transportation are complicated and time-variant, the recommendation techniques may allow the individual to make informed decisions. Notably, the recommendation techniques may allow the individual to behave in a more environmentally responsible or friendly manner, while also efficiently achieving the transportation objectives, such as completing an itinerary in a desired amount of time. Consequently, the recommendation techniques may help the individual be a responsible world citizen without an adverse impact on their quality of life.

In the discussion that follows, electronic devices, computers and/or servers (which may be local or remotely located from each other) may communicate packets or frames in accordance with a wired communication protocol and/or a wireless communication protocol. The wireless communication protocol may include: a wireless communication protocol that is compatible with an Institute of Electrical and Electronics Engineers (IEEE) 802.11 standard (which is sometimes referred to as ‘Wi-Fi®,’ from the Wi-Fi Alliance of Austin, Texas), Bluetooth, Bluetooth low energy, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, the wired communication protocol may include a wired communication protocol that is compatible with an IEEE 802.3 standard (which is sometimes referred to as ‘Ethernet’), e.g., an Ethernet II standard. However, a wide variety of communication protocols may be used. In the discussion that follows, Wi-Fi and Ethernet are used as illustrative examples.

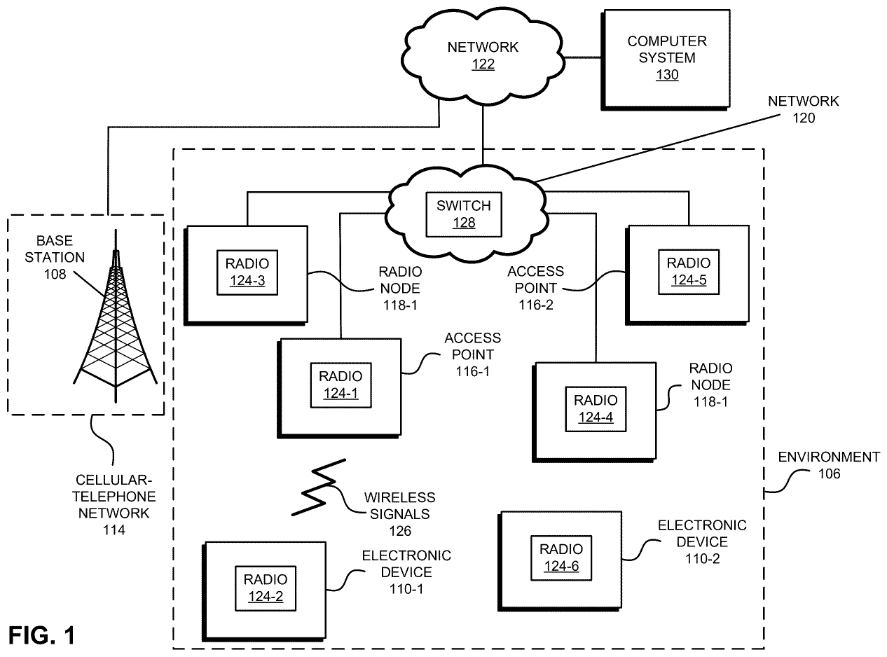

We now describe some embodiments of the recommendation techniques. FIG. 1 presents a block diagram illustrating an example of communication with electronic devices 110 (such as a cellular telephone, a portable electronic device, or another type of electronic device, etc.). Moreover, electronic devices 110 may optionally communicate via a cellular-telephone network 114 (which may include a base station 108), one or more access points 116 (which may communicate using Wi-Fi) in a wireless local area network (WLAN) and/or radio node 118 (which may communicate using LTE or a cellular-telephone data communication protocol) in a small-scale network (such as a small cell). For example, radio node 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio node 118 may be included in one or more networks, such as: a WLAN, a small cell, a local area network (LAN) and/or a cellular-telephone network. In some embodiments, access points 116 may include a physical access point and/or a virtual access point that is implemented in software in an environment of an electronic device or a computer.

Furthermore, electronic devices 110 may optionally communicate with computer system 130 (which may include one or more computers or servers, and which may be implemented locally or remotely) using a wired communication protocol (such as Ethernet) via network 120 and/or 122. Note that networks 120 and 122 may be the same or different networks. For example, networks 120 and/or 122 may be a LAN, an intra-net or the Internet. In some embodiments, the wired communication protocol may include a secured connection over transmission control protocol/Internet protocol (TCP/IP) using hypertext transfer protocol secure (HTTPS). Additionally, in some embodiments, network 120 may include one or more routers and/or switches (such as switch 128).

One or more of electronic devices 110 (such as electronic device 110-1) and/or computer system 130 may implement at least some of the operations in the recommendation techniques. Notably, as described further below, a given one of electronic devices 110 and/or computer system 130 may dynamically compute the carbon footprints associated with different types of transportation at a given time and/or may provide the recommendation information.

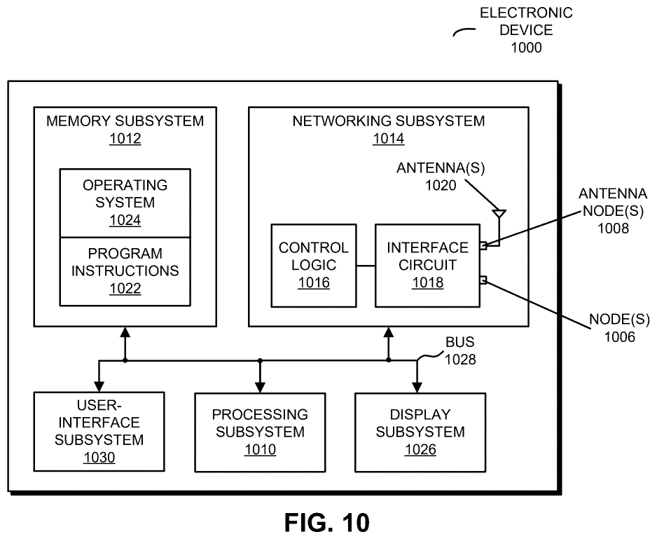

As described further below with reference to FIG. 10, base station 108, electronic devices 110, access points 116, radio node 118, switch 128, and/or computer system 130 may include subsystems, such as a networking subsystem, a memory subsystem and a processor subsystem. In addition, electronic devices 110, access points 116 and radio node 118 may include radios 124 in the networking subsystems. More generally, electronic devices 110, access points 116 and radio node 118 can include (or can be included within) any electronic devices with the networking subsystems that enable electronic devices 110, access points 116 and radio node 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, base station 108, electronic devices 110, access points 116, radio node 118 and/or computer system 130 may wired or wirelessly communicate while: transmitting access requests and receiving access responses on wired or wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio node 118 and electronic devices 110. For example, radio 124-1 in access point 116-1 may transmit information (such as one or more packets or frames) using wireless signals 126. These wireless signals are received by radio 124-2 in electronic device 110-1. This may allow access point 116-1 to communicate information to other access points 116 and/or electronic devices 110-1. Note that wireless signals 126 may convey one or more packets or frames.

In the described embodiments, processing a packet or a frame in one or more electronic devices in electronic devices 110, access points 116, radio node 118 and/or computer system 130 may include: receiving the wireless or electrical signals with the packet or the frame; decoding/extracting the packet or the frame from the received wireless or electrical signals to acquire the packet or the frame; and processing the packet or the frame to determine information contained in the payload of the packet or the frame.

Note that the wired and/or wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

While FIG. 1 illustrates computer system 130 at a particular location, in other embodiments at least a portion of computer system 130 is implemented at more than one location. Thus, in some embodiments, computer system 130 is implemented in a centralized manner, while in other embodiments at least a portion of computer system 130 is implemented in a distributed manner.

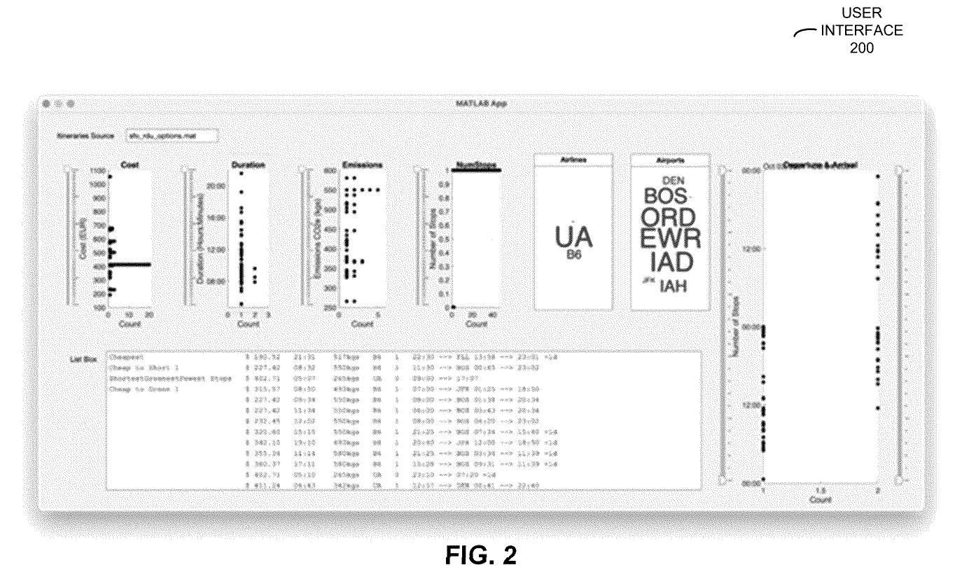

As discussed previously, individuals travelling may want to travel in a more eco-conscious way and may want to consider their environmental impact when choosing itineraries. Moreover, as described further below with reference to FIGS. 2-9, in order to address these challenges, electronic devices 110 and/or computer system 130 may perform the recommendation techniques. These capabilities may help individuals choose suitable itineraries by determining and/or estimating CO₂ equivalent emissions for various types of travel options (which are henceforth referred to as ‘types of transportation’).

Notably, picking the right itinerary to book a flight or combination of flight and other travel modes is a complicated process. Possible itineraries for a particular journey can vary in a myriad of ways. A user may choose one itinerary over another for any combination of the following differences: a cost; a total duration; a number of stops; emissions or greenness; a length of layovers; a departure airport; an arrival airport; a layover airport; a departure time; an arrival time; airline(s); a type of aircraft; and/or an amount of driving.

The current state of the art travel booking interfaces typically provide or show a long list of possible itineraries, which usually only include flight itineraries. It is then up to the consumer to make the mental comparisons between the options presented to decide which itinerary is better for their journey. For example, a consumer may be presented with two itineraries, one that is cheap but long, and another that is shorter but more expensive. The consumer must then do the mental math subtracting the prices and subtracting the durations. Once they've done this math, they can then ask themselves whether the extra cost is worth the time saved. If they want to know the fraction or percentage improvement, the consumer usually must additionally divide by the two factors to normalize the difference and create a percentage.

Many of the current state of the art interfaces do present some ‘best’ itineraries that probably balance cost and duration. We use the word ‘probably’ because the current interfaces often do not indicate how the various factors listed above are balanced against each other to determine the best options. This makes the recommendation engine opaque and difficult to trust. Furthermore, different customers have different needs from each other. Consequently, what may be best for one customer may not be best for another customer. The recommendation technique that chooses the best options usually will not consider some of the factors that may be important to a particular consumer, such as departure and/or arrival time.

Moreover, current state of the art interfaces typically have an interface for filtering based on the factors listed above. This can help find itineraries that have more complicated requirements, such as flying through a particular airport or with layovers at least two hours long. However, in current interfaces, these filters are usually hard or fixed, not soft. This means that once an itinerary is excluded because of a filter setting, that itinerary will not show up in search results and a user will not know that it has been excluded.

Once again, a consumer usually must do mental work when using the filters provided by the interface to determine what itineraries a particular filter setting may have excluded.

Furthermore, the current booking interfaces often have no feedback on the options lost when filtering, nor do they typically provide a clear indication of how various itinerary factors trade off against each other. Therefore, a user may fail to see an itinerary that they may value or they may accidentally exclude an itinerary that had value to them. Consequently, in the disclosed recommendation techniques, embodiments of user interfaces that make visible excluded filter options and/or show explicit tradeoffs between itinerary factors (or groups of itinerary factors) are provided. These embodiments help a customer make faster, more informed, and confident itinerary choice(s).

FIG. 2 presents a drawing illustrating an example of a user interface 200 in accordance with an embodiment of the present disclosure. This user interface presents the various characteristics of the available itineraries in frequency scatterplots and or word clouds.

Note that user interface 200 does not show all itinerary factors, just cost, duration, emissions, number of stops, airline, transfer airports, departure time and arrival time. The other factors may be included in a similar fashion. These frequency plots allow the user to get a sense of what the lowest cost and the median cost are likely to be. The word clouds may be used for factors (such as airlines and airports) that do not have numerical or quantitative values.

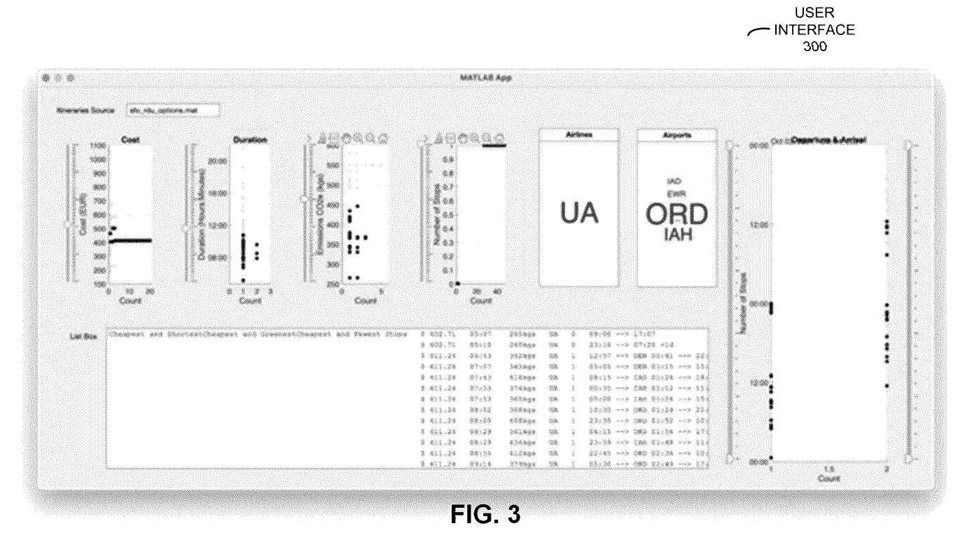

When limits to the factors are put into place with the sliders in user interface 200, one or more choices may be eliminated from the list of choices presented in the list box below. This mimics current state of the art booking interfaces, but those options remain in the graphs, plots, and word clouds of the itinerary factors in the user interface. FIG. 3, which presents a drawing illustrating an example of a user interface 300 in accordance with an embodiment of the present disclosure, shows what happens when cost, duration, and emissions limits are put in place. Note that this embodiment does not show what the word cloud with grayed out options would look like.

From user interface 300, we can see that all of the low-cost options have been eliminated with this particular set of limits. When the limit for a particular itinerary factor is lowered, an animation or some other technique may be used to draw the attention of the user to the newly eliminated options.

Another way of allowing a user to understand the consequence of the limits that they placed may be to allow for selection of some of the grayed-out options. This turns the options for a particular factor a given color (such as red) and shows where these options occur relative to the rest of the factors, and shows which limits exclude these options.

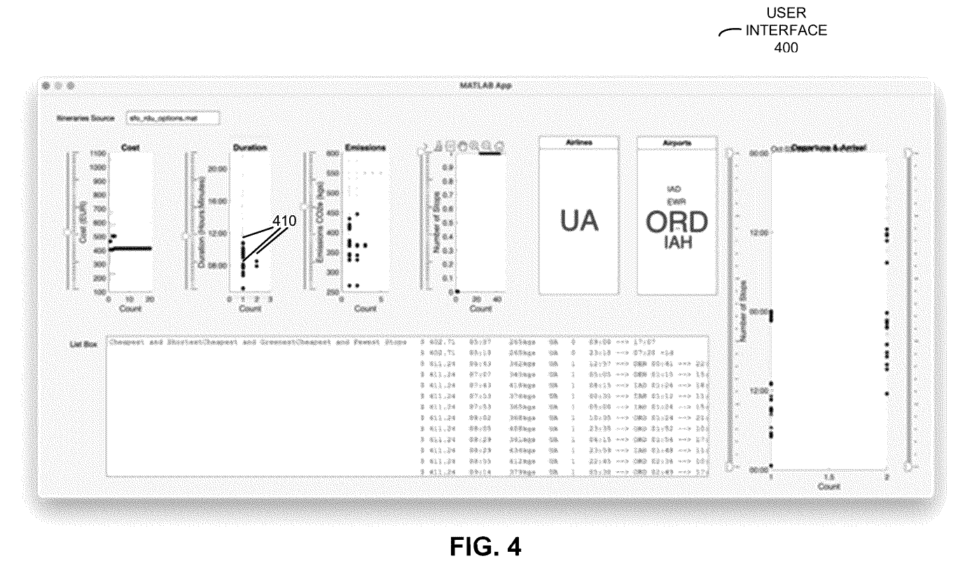

FIG. 4 presents a drawing illustrating an example of a user interface 400 in accordance with an embodiment of the present disclosure. In user interface 400, three low-cost flights have been selected to understand why they were excluded. The three duration dots 410 are all lower than the duration limit of roughly 12 hours, but the emissions of these three low-cost flights are well above the emissions limit set.

Because of the embodiments of the user interface, a user booking a flight quickly knows both that they eliminated low cost flights when they set the filter values and they can figure out what filters affect particular itinerary factors.

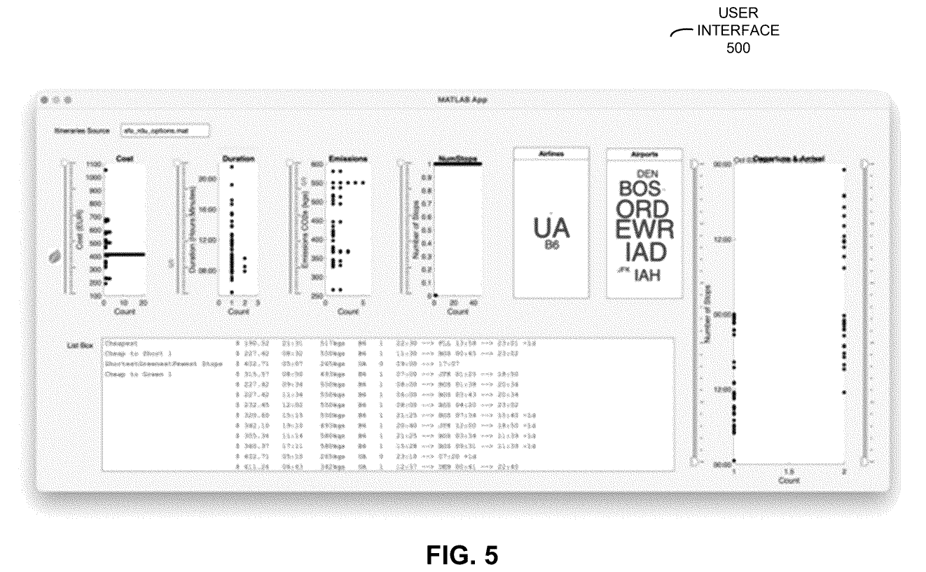

FIG. 5 presents a drawing illustrating an example of a user interface 500 in accordance with an embodiment of the present disclosure. This user interface may include hints on the sliders. These hints may help the user know when the placed limit(s) cross certain significant thresholds. The dollar sign symbol on the emissions and duration axis indicates that when the limit for either of those two factors is lowered below that marker, the cost of the itinerary will go up significantly. The green leaf icon on the cost limit slider may indicate that when the cost is limited to below the leaf, no low emissions options will be available.

The recommendation techniques placing these markers may look for inflection points at which a constraint on one factor dramatically changes the desirable options available for another constraint. By marking these inflection points, user interface 500 may allow a user to understand the points at which their options change significantly. These hints may allow a user to know what tradeoffs they are making ahead of time as they are selecting an itinerary. This capability may allow the user to more quickly constrain their options and quickly find the right choice for them.

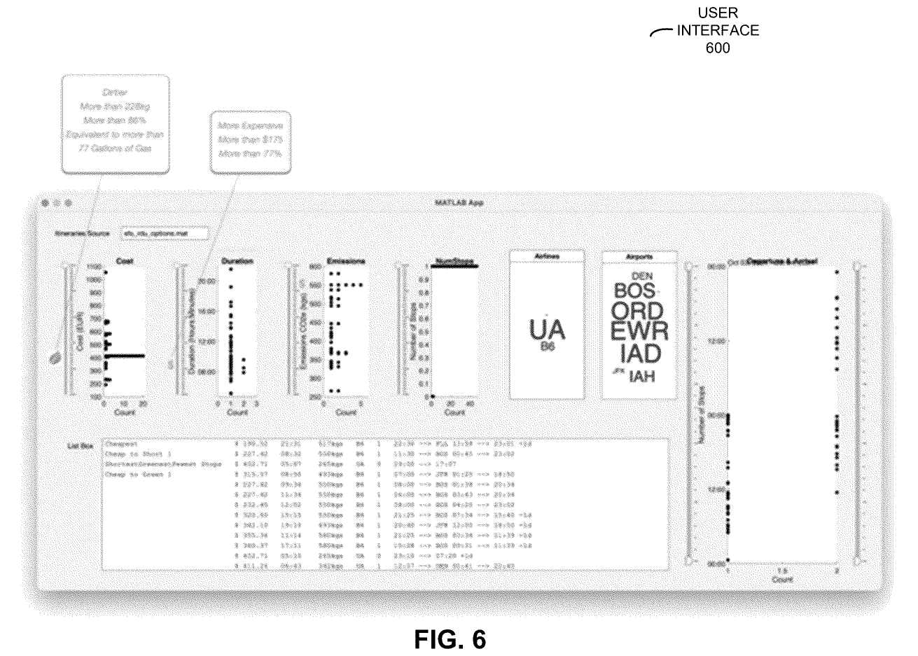

FIG. 6 presents a drawing illustrating an example of a user interface 600 in accordance with an embodiment of the present disclosure. In user interface 600, the hints are further complemented with annotation or hover text. The hover text associated with hints may address the weakness of current booking interfaces, in which users need to do mental math to fairly compare one itinerary to another. The hover text may include or present the results of the comparison calculations between the options available on either side of the constraint. This capability may allow the user to see not the absolute numbers or numerical values of particular factor(s) associated with the itineraries, but also the delta difference and the percentage difference between the options with and without the constraint. Without the hover text, a user may have to know what options disappeared or appeared when the constraint changed and then find the best itineraries to compare between the ones remaining and the ones that disappeared. Once they have identified the itineraries of interest, the user may have to do mental math to calculate the difference of the factors and the percentage difference of the factors. Alternatively, the hover text does this work for them, presenting clear comparisons, so they can make quick and accurate decisions.

In some embodiments, in order to complement the ability of the user interface to show the end user what was filtered out and excluded, we can use one or more clustering techniques to help the user select and zero in on either group of flights and/or particular filter settings. A cluster of itineraries may be a set of itineraries that share at least one common characteristic. Typically, flight itineraries in one cluster will differ from another cluster in a significant way in at least one but perhaps multiple factors. For example, there may be a cluster of cheap itineraries that has higher emission and another cluster of itineraries that are shorter and lower emission, but more expensive. In this example, the clustering differed in two factors: expense and emissions. In another example, one cluster of airlines may be similar in their lower price, while another cluster of airlines may be more expensive.

The itineraries for different journeys may create distinctly different clusters of itinerary options. For example, flights from the West Coast of the US to the East Coast tend to have clustered departures. There are typically morning departures that arrive the same day and evening departures that arrive the following morning. The later options are colloquially referred to as ‘red eye flights.’

Even the same journey, but with different dates, may have distinctly different clusters of options as prices and traffic patterns may differ between off-season and on-season.

Allowing a user to clearly know and see the clusters of options available to them allows for choices that have significance. Making a few significant choices can help to quickly narrow down options to a manageable number, while ensuring that the user keeps their most desirable options.

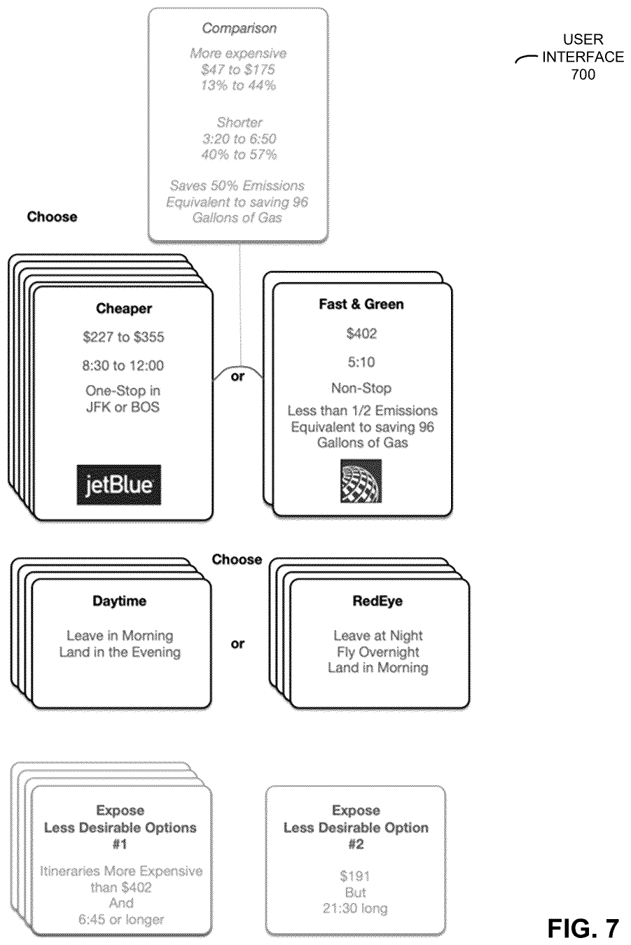

FIG. 7 presents a drawing illustrating an example of a user interface 700 in accordance with an embodiment of the present disclosure. This user interface shows how clustering may be used to aid a user as they book their journey from San Francisco to Raleigh Durham. For this journey, there are two ways that flights may be clustered. One cluster has a number of cheap, but dirty flights that create a lot of emissions. These contrast with a much smaller cluster of two flights that are more expensive, but greener. The other group of options contains two clusters, one for morning flights, and the other for red eye flights. In this example, each group of clusters is independent of the other. A user could select either cheap or green and they can additionally select either daytime or red eye. This means that with two clicks a user could select a daytime and a green itinerary and have their options narrowed down to one flight. Alternatively, a user could select a red eye and cheap flight and have their options narrowed down to a handful of options.

As these clusters are presented, information about what those options entail may also be shown in user interface 700 on the cards describing the clusters. The price or price ranges, duration or duration ranges, transfer airports, and emissions or emissions ranges can be shown.

User interface 700 may address the challenge of mental math by presenting an optional explicit comparison between two possible clusters. In FIG. 7, the user has pulled up a comparison between the cheap and dirty options and the more expensive and greener options. The comparison shows both the relative difference and the percentage difference between the two clusters both in money, time, and emissions.

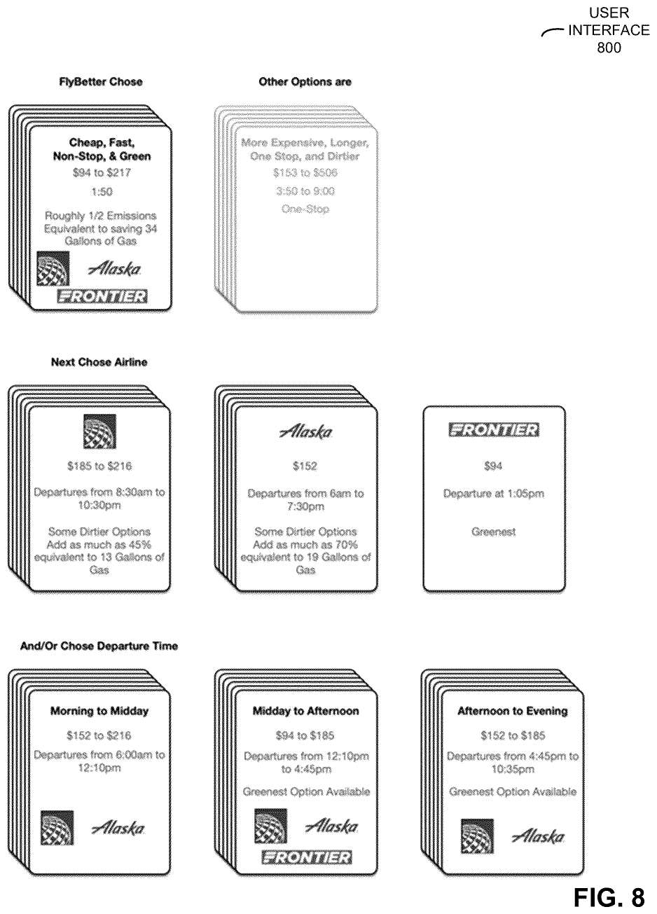

Additionally, as shown in FIG. 8, which presents a drawing illustrating an example of a user interface 800 in accordance with an embodiment of the present disclosure, the user interface may present clusters of itinerary options that have been excluded and shows why they were excluded. If the user wants to expose these options that were originally deemed undesirable, they could click on the grayed-out cluster and do so. Showing the user the fact that there are other options allows them to understand that they have choices. Explaining the reasons why these options were deprioritized allows the user interface to communicate the intelligence underlying the presented results, which gives the user more confidence in the results.

Note that the number of cards shown in a given cluster may indicate the number of itineraries in that cluster.

Note that FIG. 8 presents user interface 800 for a different journey from San Francisco to Portland Oregon, which has a different set of itinerary options. These options cluster differently and so the user may be presented with a different set of choices. In this example, there are plenty of fast non-stop options that are also cheap and green. The user interface may indicate the non-stop options for the user and may show a grayed out cluster of flights deemed less-desirable, allowing the user to know that those flights are options but that they have been deprioritized.

With the significant constraint of non-stop flights chosen, the user can quickly move to either of the next significant cluster of options, which include the choice of airline or the choice of departure time. These choices are not independent of each other, because when the user chooses Frontier Airlines that airline only has a single midday departure. Every time the user makes a choice of one cluster over another, the user interface may be updated by a recalculation of new clusters (e.g., by computer system 130) that present the user with the new set of options given the clustering constraints they have already selected.

Consider a scenario based on one or more of the options shown below in which the user accepts the non-stop constraint and then chooses a morning to midday departure cluster. In this case, the next cluster of options that they would need to choose from would probably be what airline they want to fly. But if they have made the sequence of choices outlined in the previous example, Frontier would be eliminated because it only has an afternoon departure. Consequently, in this example, only United and Alaska would be possible airlines.

Thus, in some embodiments, the user interface may allow the user to see what itineraries were lost during filtering. By changing the slider, the user can see what was eliminated, e.g., using an animation to draw attention to options that are grayed out. In this way, the user can see how many options they are eliminating.

For example, the user may be able to select an option that is grayed out to see why it was eliminated (such as a pale-red cluster of options).

In some embodiments, the user interface may: clearly indicate how much different preferences cost; the emissions per dollar; and/or the time per dollar. Moreover, the one or more clustering techniques may indicate significant thresholds that are inflection points where number of choices decreases significantly (such as by more than one itinerary). Furthermore, in some embodiments the recommendation techniques may use a gradient decent technique that starts with a particular flight and choose a variable that the user would like to improve.

While the preceding discussion illustrated the recommendation techniques as being performed by computer system 130, in other embodiments at least some of the operations in the recommendation techniques may be performed by electronic device 110-1. For example, at least some of the operations in the recommendation techniques may be performed by an application that is installed on electronic device 110-1 and that executes in an environment (such as an operating system) of electronic device 110-1. Alternatively, in some embodiments, at least some of the operations in the recommendation techniques may be performed by a browser or a browser plug-in executing in the environment of electronic device 110-1.

In some embodiments, the dynamic computations performed in the recommendation techniques may be performed using a pretrained analysis model that is trained using a machine-learning technique (such as a supervised learning technique, an unsupervised learning technique, e.g., a clustering technique, and/or a neural network) and a training dataset. For example, the pretrained analysis model may include a classifier or a regression model that was trained using: a support vector machine technique, a classification and regression tree technique, logistic regression, LASSO, linear regression, a neural network technique (such as a convolutional neural network technique, an autoencoder neural network or another type of neural network technique) and/or another linear or nonlinear supervised-learning technique. Note that computer system 130 may dynamically retrain the analysis model based at least in part on updates to the training dataset, and then may optionally provide an updated analysis model to electronic devices 110.

In these ways, the recommendation techniques may provide transparency about the environmental costs associated with the types of transportation alternatives available to the individual. Therefore, the recommendation techniques may allow the individual to make informed transportation decisions that can reduce the environmental impact of their transportation decisions. Moreover, the collective behaviors of multiple individuals may drive changes in the carbon impact or footprint of different types of transportation.

While some of the preceding embodiments illustrated the recommendation techniques with the operation of selecting a subset of travel alternatives, in other embodiments all of the travel alternatives are presented. In these embodiments, a subset may only be chosen when a user moves a slider or clicks on a card deck with travel options. Thus, in these embodiments, the user may work through an active selection of a subset of the travel alternatives.

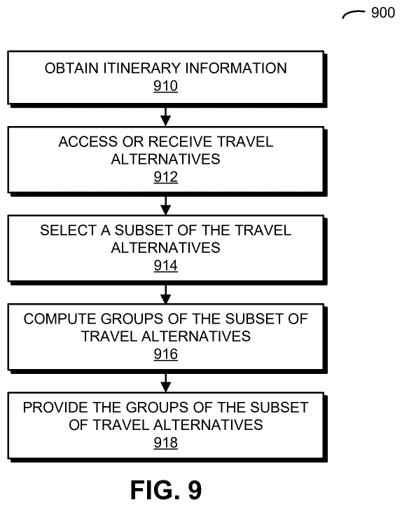

We now describe embodiments of the method. FIG. 9 presents a flow diagram illustrating an example of a method 900 for providing recommendation information, which may be performed by a computer system (such as computer system 130 in FIG. 1) and, more generally, an electronic device (such as electronic device 110-1 in FIG. 1). During operation, the electronic device may obtain itinerary information (operation 910) associated with an individual. Then, the electronic device may access or receive travel alternatives (operation 912) based at least in part on the itinerary information. Note that the travel alternatives may be precomputed and stored in memory, or may be computed based at least in part on stored information. Moreover, the electronic device may select a subset of the travel alternatives (operation 914) based at least in part on one or more travel constraints. Next, the electronic device may compute, using a clustering technique, groups of the subset of travel alternatives (operation 916), where a given group in the subset of travel alternatives includes a set of one or more travel alternatives having at least one common characteristic, and the travel alternatives in different clusters are different from each other in at least one travel constraint. Furthermore, the electronic device may provide the groups of the subset of the travel alternatives (operation 918), where the providing includes providing instructions for a user interface that presents the groups of the subset of the travel alternatives.

Note that the travel alternatives may include different itineraries.

Moreover, the travel constraints may include a constraint on emissions (such as CO₂).

Furthermore, the electronic device may include a second group of travel alternatives in the instructions for the user interface, where the second group of travel alternatives includes one or more travel alternatives that were excluded based at least in part on the one or more travel constraints. Note that the second group of travel alternatives may have a different color from the groups of the subset of the travel alternatives in the instructions for the user interface.

Additionally, the one or more travel constraints may be user-defined.

In some embodiments, the electronic device may dynamically revise the groups of the subset of travel alternatives and/or may provide the revised groups of the subset of the travel alternatives (such as in revised instructions for the user interface) based at least in part on one or more user selections associated with the previous instructions for the user interface.

Note that the instructions for the user interface may include labels with values or summaries of the one or more travel constraints for the groups of the subset of the travel alternatives.

In some embodiments of method 900, there may be additional or fewer operations. Furthermore, the order of the operations may be changed, and/or two or more operations may be combined into a single operation.

The disclosed recommendation techniques may be implemented in a variety of ways, including: using a client-server architecture, an installed standalone application on an electronic device, via a Web browser, etc. For example, some operations may be performed locally, while others may be performed remotely. Therefore, the disclosed recommendation techniques may be implemented in a centralized and/or a distributed manner. In some embodiments, the disclosed recommendation techniques are implemented using hardware and/or software and may involve communication and accessing data from other computer systems (such as from an airline, a travel agent, etc.).

Moreover, the disclosed recommendation techniques may be performed in a variety of ways. In some embodiments, the difference factors may be used as inputs to a pretrained predictive model, which may output a set of one or more itineraries and/or transportation modalities, along with their associated environmental impacts, travel time, cost, etc.

In general, the disclosed user interfaces may include fewer or additional features (or user-interface objects), two or more features may be combined, a feature may be separated into two features, and/or there may be different features.

We now describe embodiments of an electronic device, which may perform at least some of the operations in the recommendation techniques. FIG. 10 presents a block diagram illustrating an example of an electronic device 1000, e.g., one of electronic devices 110, access points 116, radio node 118, switch 128, and/or a computer or server in computer system 130, in accordance with some embodiments. For example, electronic device 1000 may include: processing subsystem 1010, memory subsystem 1012, and networking subsystem 1014. Processing subsystem 1010 includes one or more devices configured to perform computational operations. For example, processing subsystem 1010 can include one or more microprocessors, ASICs, microcontrollers, programmable-logic devices, GPUs and/or one or more DSPs. Note that a given component in processing subsystem 1010 are sometimes referred to as a ‘computation device’.

Memory subsystem 1012 includes one or more devices for storing data and/or instructions for processing subsystem 1010 and networking subsystem 1014. For example, memory subsystem 1012 can include dynamic random access memory (DRAM), static random access memory (SRAM), and/or other types of memory. In some embodiments, instructions for processing subsystem 1010 in memory subsystem 1012 include: program instructions or sets of instructions (such as program instructions 1022 or operating system 1024), which may be executed by processing subsystem 1010. Note that the one or more computer programs or program instructions may constitute a computer-program mechanism. Moreover, instructions in the various program instructions in memory subsystem 1012 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1010.

In addition, memory subsystem 1012 can include mechanisms for controlling access to the memory. In some embodiments, memory subsystem 1012 includes a memory hierarchy that comprises one or more caches coupled to a memory in electronic device 1000. In some of these embodiments, one or more of the caches is located in processing subsystem 1010.

In some embodiments, memory subsystem 1012 is coupled to one or more high-capacity mass-storage devices (not shown). For example, memory subsystem 1012 can be coupled to a magnetic or optical drive, a solid-state drive, or another type of mass-storage device. In these embodiments, memory subsystem 1012 can be used by electronic device 1000 as fast-access storage for often-used data, while the mass-storage device is used to store less frequently used data.

Networking subsystem 1014 includes one or more devices configured to couple to and communicate on a wired and/or wireless network (i.e., to perform network operations), including: control logic 1016, an interface circuit 1018 and one or more antennas 1020 (or antenna elements). (While FIG. 10 includes one or more antennas 1020, in some embodiments electronic device 1000 includes one or more nodes, such as antenna nodes 1008, e.g., a metal pad or a connector, which can be coupled to the one or more antennas 1020, or nodes 1006, which can be coupled to a wired or optical connection or link. Thus, electronic device 1000 may or may not include the one or more antennas 1020. Note that the one or more nodes 1006 and/or antenna nodes 1008 may constitute input(s) to and/or output(s) from electronic device 1000.) For example, networking subsystem 1014 can include a Bluetooth™ networking system, a cellular networking system (e.g., a 3G/4G/5G network such as UMTS, LTE, etc.), a USB networking system, a networking system based on the standards described in IEEE 802.11 (e.g., a Wi-Fi® networking system), an Ethernet networking system, and/or another networking system.

Networking subsystem 1014 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between electronic devices does not yet exist. Therefore, electronic device 1000 may use the mechanisms in networking subsystem 1014 for performing simple wireless communication between electronic devices, e.g., transmitting advertising or beacon frames and/or scanning for advertising frames transmitted by other electronic devices.

Within electronic device 1000, processing subsystem 1010, memory subsystem 1012, and networking subsystem 1014 are coupled together using bus 1028. Bus 1028 may include an electrical, optical, and/or electro-optical connection that the subsystems can use to communicate commands and data among one another. Although only one bus 1028 is shown for clarity, different embodiments can include a different number or configuration of electrical, optical, and/or electro-optical connections among the subsystems.

In some embodiments, electronic device 1000 includes a display subsystem 1026 for displaying information on a display, which may include a display driver and the display, such as a liquid-crystal display, a multi-touch touchscreen, etc. Moreover, electronic device 1000 may include a user-interface subsystem 1030, such as: a mouse, a keyboard, a trackpad, a stylus, a voice-recognition interface, and/or another human-machine interface.

Electronic device 1000 can be (or can be included in) any electronic device with at least one network interface. For example, electronic device 1000 can be (or can be included in): a desktop computer, a laptop computer, a subnotebook/netbook, a server, a supercomputer, a tablet computer, a smartphone, a smartwatch, a cellular telephone, a consumer-electronic device, a portable computing device, communication equipment, and/or another electronic device.

Although specific components are used to describe electronic device 1000, in alternative embodiments, different components and/or subsystems may be present in electronic device 1000. For example, electronic device 1000 may include one or more additional processing subsystems, memory subsystems, networking subsystems, and/or display subsystems. Additionally, one or more of the subsystems may not be present in electronic device 1000. Moreover, in some embodiments, electronic device 1000 may include one or more additional subsystems that are not shown in FIG. 10. Also, although separate subsystems are shown in FIG. 10, in some embodiments some or all of a given subsystem or component can be integrated into one or more of the other subsystems or component(s) in electronic device 1000. For example, in some embodiments program instructions 1022 are included in operating system 1024 and/or control logic 1016 is included in interface circuit 1018.

Moreover, the circuits and components in electronic device 1000 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1014 and/or electronic device 1000. The integrated circuit may include hardware and/or software mechanisms that are used for transmitting signals from electronic device 1000 and receiving signals at electronic device 1000 from other electronic devices. Aside from the mechanisms herein described, radios are generally known in the art and hence are not described in detail. In general, networking subsystem 1014 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the recommendation techniques may be implemented using program instructions 1022, operating system 1024 (such as a driver for interface circuit 1018) or in firmware in interface circuit 1018. Thus, the recommendation techniques may be implemented at runtime of program instructions 1022. Alternatively or additionally, at least some of the operations in the recommendation techniques may be implemented in a physical layer, such as hardware in interface circuit 1018.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the recommendation techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit;
a processor coupled to the interface circuit; and
memory, coupled to the processor, storing program instructions, wherein, when executed by the processor, the program instructions cause the electronic device to perform operations comprising:
obtaining itinerary information associated with an individual;
accessing or receiving travel alternatives based at least in part on the itinerary information;
selecting a subset of the travel alternatives based at least in part on one or more travel constraints;
computing, using a clustering technique, groups of the subset of travel alternatives, wherein a given group in the subset of travel alternatives comprises a set of one or more travel alternatives having at least one common characteristic, and the travel alternatives in different clusters are different from each other in at least one travel constraint; and
providing the groups of the subset of the travel alternatives, wherein the providing comprises providing instructions for a user interface that presents the groups of the subset of the travel alternatives.

2. The electronic device of claim 1, wherein the travel alternatives comprise different itineraries.

3. The electronic device of claim 1, wherein the travel constraints comprise a constraint on emissions.

4. The electronic device of claim 3, wherein the constraint on emissions comprises a constraint on CO₂ released during a given travel itinerary.

5. The electronic device of claim 1, wherein the electronic device includes a second group of travel alternatives in the instructions for the user interface; and
wherein the second group of travel alternatives comprises one or more travel alternatives that were excluded based at least in part on the one or more travel constraints.

6. The electronic device of claim 5, wherein the second group of travel alternatives has a different color from the groups of the subset of the travel alternatives in the instructions for the user interface.

7. The electronic device of claim 1, wherein the one or more travel constraints are user-defined.

8. The electronic device of claim 1, wherein the operations comprise dynamically revising the groups of the subset of travel alternatives and providing the revised groups of the subset of the travel alternatives based at least in part on one or more user selections associated with a previous instance of the user interface.

9. The electronic device of claim 1, wherein the instructions for the user interface comprise labels with values or summaries of the one or more travel constraints for the groups of the subset of the travel alternatives.

10. A non-transitory computer-readable storage medium for use in conjunction with an electronic device, the computer-readable storage medium storing program instructions that, when executed by the electronic device, causes the electronic device to perform operations comprising:
obtaining itinerary information associated with an individual;
accessing or receiving travel alternatives based at least in part on the itinerary information;
selecting a subset of the travel alternatives based at least in part on one or more travel constraints;
computing, using a clustering technique, groups of the subset of travel alternatives, wherein a given group in the subset of travel alternatives comprises a set of one or more travel alternatives having at least one common characteristic, and the travel alternatives in different clusters are different from each other in at least one travel constraint; and
providing the groups of the subset of the travel alternatives, wherein the providing comprises providing instructions for a user interface that presents the groups of the subset of the travel alternatives.

11. The non-transitory computer-readable storage medium of claim 10, wherein the travel alternatives comprise different itineraries.

12. The non-transitory computer-readable storage medium of claim 10, wherein the travel constraints comprise a constraint on emissions.

13. The non-transitory computer-readable storage medium of claim 10, wherein the operations comprise dynamically revising the groups of the subset of travel alternatives and providing the revised groups of the subset of the travel alternatives based at least in part on one or more user selections associated with a previous instance of the user interface.

14. The non-transitory computer-readable storage medium of claim 10, wherein the instructions for the user interface comprise labels with values or summaries of the one or more travel constraints for the groups of the subset of the travel alternatives.

15. A method for providing recommendation information, comprising:
by an electronic device:
obtaining itinerary information associated with an individual;
accessing or receiving travel alternatives based at least in part on the itinerary information;
selecting a subset of the travel alternatives based at least in part on one or more travel constraints;
computing, using a clustering technique, groups of the subset of travel alternatives, wherein a given group in the subset of travel alternatives comprises a set of one or more travel alternatives having at least one common characteristic, and the travel alternatives in different clusters are different from each other in at least one travel constraint; and
providing the groups of the subset of the travel alternatives, wherein the providing comprises providing instructions for a user interface that presents the groups of the subset of the travel alternatives.

16. The method of claim 15, wherein the travel alternatives comprise different itineraries.

17. The method of claim 15, wherein the travel constraints comprise a constraint on emissions.

18. The method of claim 17, wherein the constraint on emissions comprises a constraint on CO₂ released during a given travel itinerary.

19. The method of claim 15, wherein the method comprises dynamically revising the groups of the subset of travel alternatives and providing the revised groups of the subset of the travel alternatives based at least in part on one or more user selections associated with a previous instance of the user interface.

20. The method of claim 15, wherein the instructions for the user interface comprise labels with values or summaries of the one or more travel constraints for the groups of the subset of the travel alternatives.
